(19) United States
(12) Patent Application Publication
(10) Pub. No.: US 2002/0090931 A1
(43) Pub. Date: Jul. 11, 2002

(54) Fly - safe operating mode for smart phone

(76) Inventors: Scott Papineau, Leawood, KS (US); Donald R. Green, San Marcos, CA (US)

Correspondence Address: SCOTT C. HARRIS, Fish & Richardson P.C., 4350 La Jolla Village Drive, Suite 500, San Diego, CA, 92122, US

(21) Appl. No.: 09/760,507

(22) Filed: Jan. 11, 2001

(51) Int. Cl. H04M 1/66

(52) U.S. Cl. 455/411; 455/574; 455/556

(57) ABSTRACT

In an embodiment, a wireless phone having both communications and non-communications functions may be operated in a communications disabled operating mode appropriate for transmission restricted environments, such as an airplane in flight. Power may be supplied to a component in a communications module of the phone, for example, one or more local oscillators in a frequency converter. A processor in the phone may control a switch to cut off power to that component in response to a command input to the phone while maintaining control and the power supply to components supporting non-communications of the phone. A user may enter the command through a user interface including, for example, a display screen, a speaker, and input keys, buttons, and/or switches. The display screen may display an indicator such as a graphical icon or textual banner that indicates that the phone is operating in the communications disabled operating mode.

### TECHNICAL FIELD

This invention relates to telephones that perform communications and non-communications functions, and more particularly to selectively disabling the communications functions of such telephones.

### BACKGROUND

Many airlines prohibit the use of electronic devices that intentionally transmit radio signals during flight. These intentional transmitters include, for example, cellular telephones, amateur radio transceivers, and remote control devices. Many airlines may permit the use of other types of electronic devices during flight. These devices may include laptop computers, video cameras, electronic game devices, and compact disc and tape players.

Cellular telephones may perform functions other than placing and receiving telephone calls. Some cellular telephones may have personal digital assistant (PDA) features. The PDA features may include, for example, a scheduler for recording appointments and reminders, schedule-based alarms, games, and an organizer that includes contact information.

It may be desirable to enable the non-communications, e.g., PDA, features of a cellular telephone while disabling the communications features of the telephone for use in transmission restricted environments, such as airplanes in flight and hospitals with wireless monitoring devices.

### SUMMARY

In an embodiment, a wireless phone having both communications and non-communications functions may be operated in a communications disabled operating mode appropriate for transmission restricted environments, such as an airplane in flight. Power may be supplied to a component in a communications module of the phone, for example, one or more local oscillators in a frequency converter. A processor in the phone may control a switch to cut off power to that component in response to a command input to the phone while maintaining control and the power supply to components supporting non-communications of the phone. A user may enter the command through a user interface including, for example, a display screen, a speaker, and input keys, buttons, and/or switches. The display screen may display an indicator such as a graphical icon or textual banner that indicates that the phone is operating in the communications disabled operating mode.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates the components of an exemplary communication system including a smart phone according to an embodiment.

FIG. 2 is a schematic diagram including components used for communications-specific and general-purpose and non-communications components of the smart phone.

FIG. 3 is a plan view of a smart phone according to an embodiment.

### DETAILED DESCRIPTION

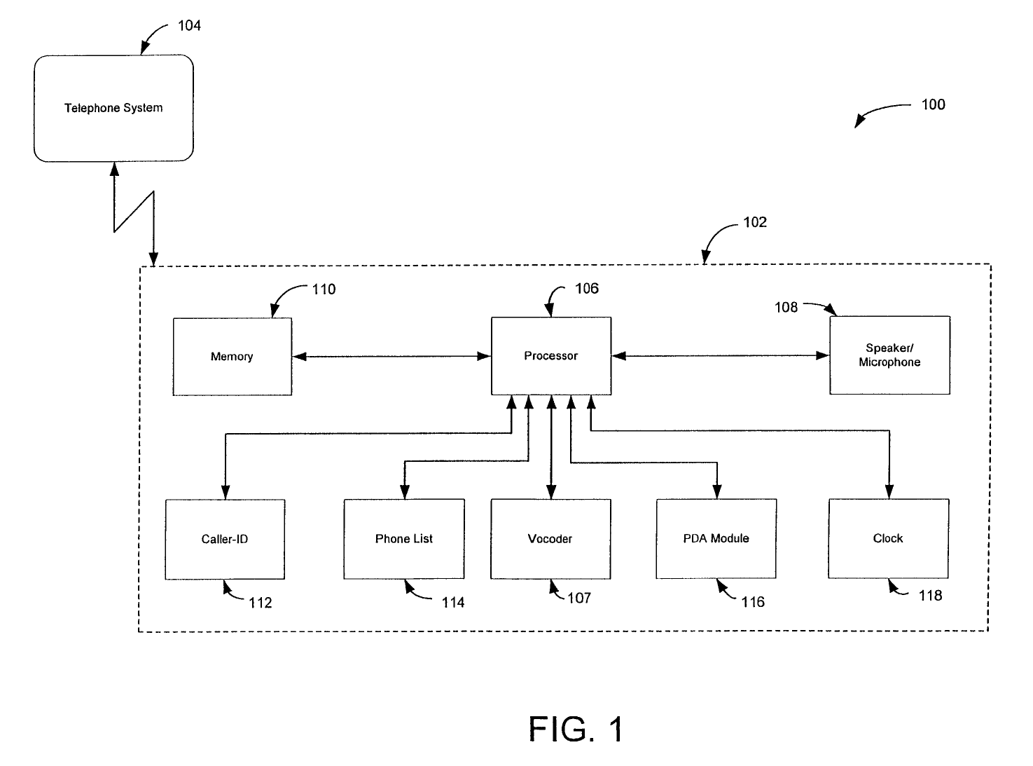

FIG. 1 depicts a communication system 100 according to an embodiment. The communication system may include a smart phone 102 and a telephone system 104. The telephone system 104 may be a wireless system such as cellular or Personal Communications Services (PCS). The smart phone 102 may communicate with the telephone system 104 through wireless radio frequencies.

The smart phone 102 may perform a variety of functions in addition to allowing a user to communicate over the telephone system 104. The smart phone 102 may include, among other things, a processor 106, a vocoder (voice coder-decoder) 107, a speaker/microphone 108, a memory 110, caller-id circuitry 112, a stored phone list 114, a personal digital assistant (PDA) module 116, and a clock 118. Although shown as separate components, several of the items in the smart phone 102 may be combined into a single semiconductor device or circuit. For example, the processor 106, the vocoder 107, the caller-id circuitry 112, and the PDA module 116 may be a single unit. Other components such as the speaker/microphone 108 may be embodied as separate components.

Words spoken into the microphone 108 may be digitized by the vocoder 107 and stored as an audio recording in the memory 110. The size of the memory 110 may determine the amount of recording the smart phone 102 is capable of storing. Each of the audio recordings may receive an identifier by the processor 106. The smart phone 102 may also include pre-recorded audio recordings stored in the memory 110.

The user may store a plurality of frequently called numbers in the phone list 114. After the numbers have been stored in the phone list 114, the numbers may be dialed automatically by accessing the phone list 114. Generally, each number in the phone list 114 has an associated descriptive name (e.g., “David” or “Home”) to identify the number. In the smart phone 102, each number may also have an associated audio recording to identify the number. The vocoder 107 may interpret a spoken phrase and compare it to the audio recordings. If the spoken phrase matches one of the audio recordings, the associated number in the phone list 114 may be dialed automatically. The phone list 114 may also be searched by stored number.

The caller-id circuitry 112 may enable the smart phone 102 to determine the telephone number of the calling party upon receiving the call. The caller-id circuitry 112 may include use of ANI (Automatic Number Identification). ANI is a mechanism by which the different telephone companies may determine what account is to be charged for a call. This information is passed between telephone companies and was originally for billing purposes. Caller-ID services offered to telephone company customers are based on ANI. Currently there are two types of caller-ID. The first (often referred to as “basic” service) just returns the calling number or an error message and the date/time of the call. The second (often referred to as “enhanced” caller-ID) may also return the directory information about the calling number.

The PDA module 116 may perform a variety of non-communications functions. For example, the PDA module 116 may function as a scheduler and store information relating to appointments, store alarms, maintain contact information, and perform a variety of other tasks. The PDA module 116 may notify the user when an alarm condition occurs, such as a predetermined amount of time before a scheduled meeting. The PDA module 116 may also function as an organizer, and record and store personal and contact information.

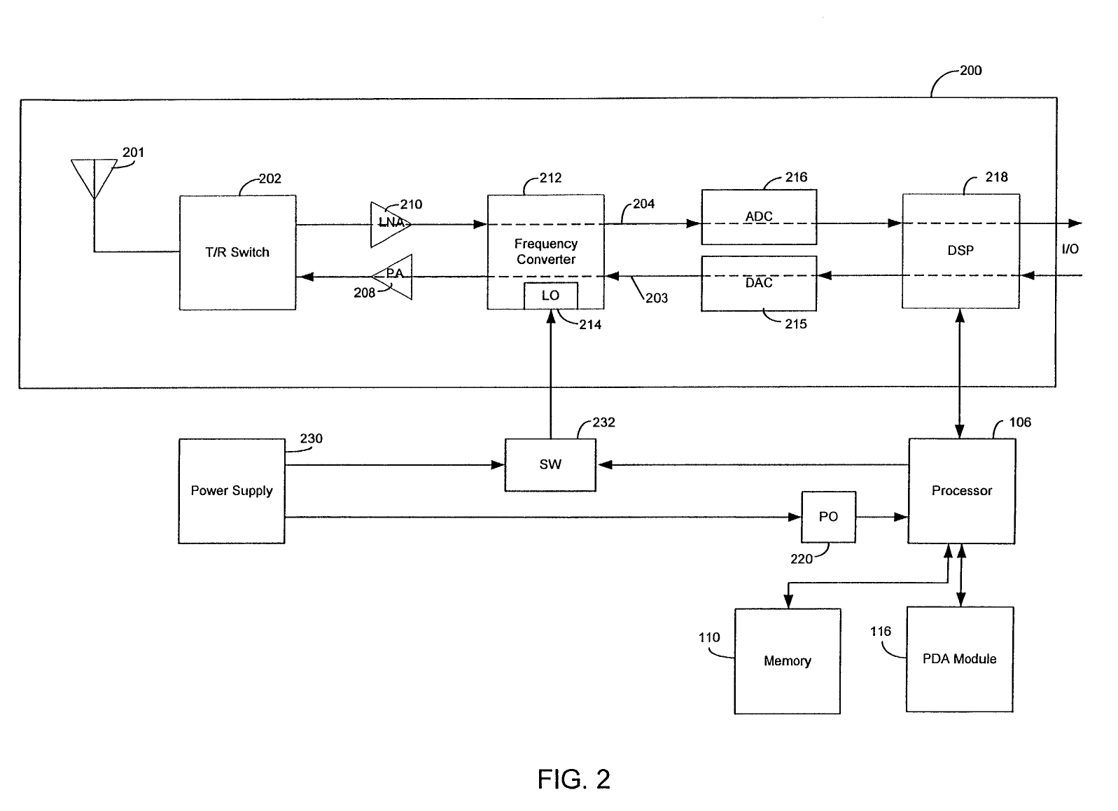

FIG. 2 illustrates a communications module 200 including components that may be utilized to perform the communications, e.g., telephonic or computer network, functions of the smart phone 102 and components used for non-communications, e.g., PDA, functions. According to an embodiment, a user may disable the communications functions of the smart phone 102 by cutting off power to certain communications-specific components while maintaining the ability of the smart phone 102 to perform non-communication functions by maintaining control of, and power supplied to, components supporting the non-communications functions. This communications disabled operating mode may be advantageous in certain transmission-restricted environments, for example, airplanes in flight and hospitals with wireless monitoring systems.

The communications module 200 may include an antenna 201, to transmit and receive radio frequency (RF) signals and a transmit/receive (T/R) switch 202 to switch between communications signals on a transmission path 203 and a reception path 204. RF signals to be transmitted may be amplified by a power amplifier 208 in the transmission path 203. RF signals received by the antenna 201 may be amplified by a low noise amplifier (LNA) 210 in the reception path 204.

Many digital cellular phones include a “down-conversion” in their signal chain. This frequency conversion may shift the desired signal from the allocated RF band for the standard (e.g., at 900 MHz) to some lower intermediate frequency (IF), where channel selection may be performed with a narrow channel-select filter. The filtered signal may then be further down-converted to either a second IF or directly to base band, where it may be digitized and demodulated in a digital signal processor (DSP) 218 in the communications module 200. Signals may be stepped between RF frequencies and base band through one or more intermediate frequency (IF) ranges by the frequency converter 212 in one or more conversion stages. Each conversion stage of the frequency converter 212 may include a local oscillator (LO) 214. Each conversion stage may also include a frequency synthesizer to lock the LO 214 to a given frequency, a mixer, a filter, and an amplifier.

A digital-to-analog converter (DAC) 215 in the transmission path 203 may convert digital signals output from the DSP 218 for input to the frequency converter 212. An analog-to-digital converter (ADC) 216 in the reception path 204 may convert analog signals from the frequency converter 212 to digital signals for input to the DSP 218.

The processor 106 may control components in the communications module 200, e.g., the DSP 218, as well as non-communications components, such as the PDA module 116 and the memory 110, as shown in FIG. 1. A processor oscillator 220 may provide timing for the processor 106. The processor oscillator 220 may be a temperature compensated crystal oscillator (TCXO). TXCOs may employ a thermistor network to generate a correction voltage in order to reduce frequency drift in the oscillator when the ambient temperature changes.

A power supply module 230 may supply power to the LO 214 of the communications module 202, the processor oscillator 220, and other components in the smart phone 102. The processor 106 may control power supplied to the LO 214 through a switch 232. The processor 106 may control the switch 232 to cut off power to the LO 214, thereby disabling the communication module 202, in response to a communications-disable command. The switch 232 may be implemented in hardware or software.

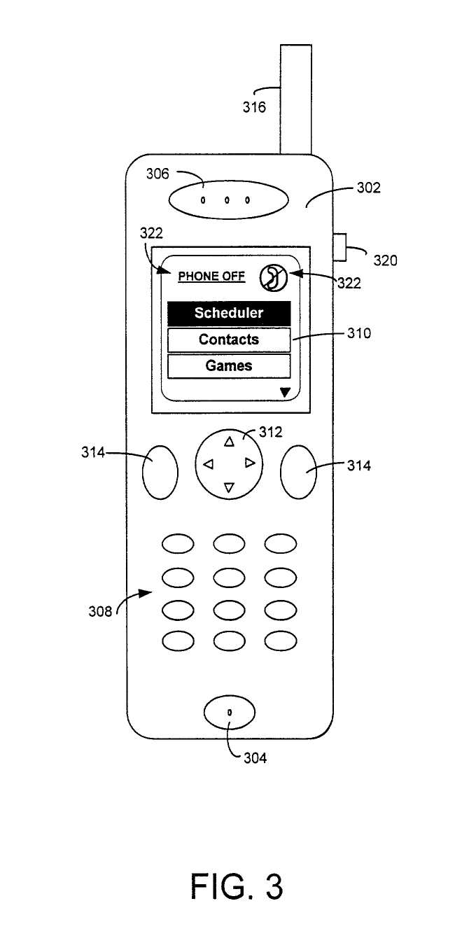

FIG. 3 illustrates a smart phone 300 including a userinterface according to an embodiment. The smart phone 300 may include a housing 302, a microphone 304, a speaker 306, a keypad 308, a display screen 310, a multi-directional toggle button 312, control keys 314, and an antenna 316.

Certain features of the smart phone 300 may be menu driven. Various menus, and subordinate menu levels, may be displayed on the display screen 310. The user may navigate through the menus and enter commands using voice commands through the speaker 304 and/or by manipulating the toggle button 312, control buttons 314, and/or keys in the keypad 308.

The user may enter the command to disable the communications module 202 by navigating through a menu to a prompt for the communications disabled operating mode and selecting that prompt. Alternatively, a dedicated button or switch 320 may be provided on the housing 302, which may issue the communications-disable command to the processor 106 when pressed. An indicator 322 may be displayed on the display screen 310 while the smart phone 102 is in the communications disabled operating mode. The indicator 322 may be a graphical icon or a textual banner that may read, for example, “PHONE OFF”. The indicator 322 verifies that the phone is not operating as an intentional transmitter, but rather as a permissible electronic device, e.g., a PDA or electronic game device.

A number of embodiments of the invention have been described. Nevertheless, it will be understood that various modifications may be made without departing from the spirit and scope of the invention. Accordingly, other embodiments are within the scope of the following claims.

What is claimed is:

1. A method for utilizing a telephone in a communications disabled mode, comprising:
issuing a communications-disable command; and
disabling a communication function of the telephone and enabling a non-communication function of the telephone responsive to said communication-disabled command.

2. The method of claim 1, further comprising:
displaying an indicator on the telephone indicating that the telephone is in the communications disabled mode.

3. The method of claim 1, wherein said disabling the communication function comprises disabling a frequency conversion function.

4. The method of claim 1, wherein disabling the communications function comprises cutting off power to a local oscillator in the telephone.

5. The method of claim 1, wherein the non-communications function comprises a personal digital assistant function.

6. The method of claim 1, wherein issuing the communications-disable command comprises giving a voice command.

7. The method of claim 1, wherein issuing the communications-disable command comprises selecting a menu item.

8. The method of claim 1, wherein the issuing the communications-disable command comprises depressing a dedicated key.

9. A telephone comprising:
a communications module comprising a plurality of communications components;
a non-communications module;
a power supply coupled to the non-communications module and coupled to a communications component through a switch;
an interface to input a command; and
a processor coupled to the communications module, the non-communications module, and the switch, said processor operative to control the switch to cut off power supplied to the communications component in response to the input command.

10. The telephone of claim 9, wherein the communications component comprises a frequency converter.

11. The telephone of claim 9, wherein the communications component comprises a local oscillator.

12. The telephone of claim 9, wherein the non-communications module comprises a personal digital assistant module.

13. The telephone of claim 9, further comprising a display screen coupled to the processor, wherein the processor is further operative to display an indicator on the display screen in response to the input command.

14. The telephone of claim 13, wherein the indicator comprises a textual banner indicating a communications disabled operating mode.

15. The telephone of claim 13, wherein the indicator comprises a graphical icon indicating a communications disabled operating mode.

16. The telephone of claim 9, wherein the interface comprises a speaker.

17. The telephone of claim 9, wherein the interface comprises a button or a switch.

18. A communications system comprising:
a plurality of communications devices including a telephone, said telephone comprising:
a communications module comprising a plurality of communications components;
a non-communications module;
a power supply coupled to the non-communications module and coupled to a communications component through a switch;
an interface to input a command; and
a processor coupled to the communications module, the non-communications module, and the switch, said processor operative to control the switch to cut off power supplied to the communications component in response to the input command; and
a plurality of nodes for transmitting communications signals between communications devices and other nodes in the system.

19. The system of claim 18, wherein the communications component comprises a frequency converter.

20. The system of claim 18, wherein the communications component comprises a local oscillator.

21. The system of claim 19, wherein the non-communications module comprises a personal digital assistant module.

22. The system of claim 19, wherein the telephone further comprises a display screen coupled to the processor, and wherein the processor is further operative to display an indicator on the display screen in response to the input command.

23. The system of claim 22, wherein the indicator comprises a textual banner indicating a communications disabled operating mode.

24. The system of claim 22, wherein the indicator comprises a graphical icon indicating a communications disabled operating mode.

25. The system of claim 18, wherein the interface comprises a speaker.

26. The system of claim 18, wherein the interface comprises a button or a switch.
